(19) United States
(12) Patent Application Publication
(10) Pub. No.: US 2022/0182010 A1
(43) Pub. Date: Jun. 9, 2022

(54) PHOTOVOLTAIC MODULE FASTENING SYSTEMS II

(71) Applicant: Erthos IP LLC, Tempe, AZ (US)

(72) Inventors: William T. HAMMACK, Taos, NM (US); Michael Alexander GLADKIN, Flagstaff, AZ (US)

(21) Appl. No.: 17/542,333

(22) Filed: Dec. 3, 2021

Related U.S. Application Data
(60) Provisional application No. 63/120,931, filed on Dec. 3, 2020.

(51) Int. Cl. H02S 30/10; H02S 40/34; F16B 5/06

(52) U.S. Cl. CPC H02S 30/10; F16B 5/0607; H02S 40/34

(57) ABSTRACT

A PV module alignment or attachment system and method that contains multi-connectors that interact with the modules along rows or columns of an array of the modules. In some versions, the multi-connectors connect to frames of the modules in a row or column and maintain the module-to-module height between modules. The multi-connectors connect to flanges on the frames, which flanges are molded into the frames or bolted to the frames.

### CROSS-REFERENCE TO RELATED APPLICATIONS

This application is related to and claims priority to U.S. Provisional Patent Application No. 63/120,931, filed on Dec. 3, 2020. The entire content of the priority application is incorporated by this reference.

### BACKGROUND

### Technical Field

The disclosed technology relates to the mounting of solar panels using a terrestrial or ground-based mounting system.

### Background Art

Solar panels or modules are assemblies of multiple photovoltaic (PV) cells hardwired to form a single unit, typically as a rigid piece. Flexible solar panels are known, as well. Multiple solar panels form an array with strings of panels wired together. These strings connect to a power receiving unit, typically an inverter or controller, which provides an initial power output. One or more solar arrays form a solar plant.

A silicon-based PV module, also commonly called crystalline silicon (c-Si) PV module, is a packaged, connected assembly of typically 6×12 photovoltaic solar cells. But this can vary according to design choice. Other types of PV cell technology include “thin-film” and variations of silicon-based technology. Two thin-film module technologies stand out. The first is CdTe (Cadmium Tellurium), also known as CadTel. The second is CIGS or CIS (Copper, Indium, Gallium, Selenium or Copper, Indium, Selenium).

The number of panels making up a string can vary. Strings can contain 17-29 panels in typical applications depending on the environmental condition and the module's rated voltage (string voltage). The row size of panels in a row of Single Axis Tracker (SAT) and Fixed Tilt (FT) systems can vary, and a typical row is three (3) strings of 26-28 panels per row for SAT systems summing to between 76-84 panels per row. A single row is limited by geographical grade changes within the span of the row and rigid structural limitations based on the typical steel structure. Multiple rows of solar panels make up an array of solar panels. The array size is limited by power transmission limitations, including limiting maximum voltage and current at the Power Conversion Station and Medium Voltage Step Up Transformer. The panels within an array may be connected in one or more series or parallel strings. A series string is a set of panels series connected to increase voltage typically limited to 1500V DC per string for a Utility-Scale Solar System. Arrays are often divided into multiple strings of equal voltage connected in parallel to sum the current. This arrangement limits the maximum voltage output of a string and the maximum current output of an array.

Thus, solar cells internally connect within a panel. And panels connect within a string. Multiple strings connect within a row. Multiple rows form an array that feeds into an inverter or inverters either directly or through wiring harnesses. Multiple inverters are connected to further output circuitry, commonly MV Transformers, which are connected to transmission circuitry. The strings are connected directly or through wiring harness connections to the inverter.

The goal is to reduce the Levelized cost of energy (LCOE) for the PV power plants. The utility-scale PV power plant is unique from the many other solar power and electricity production forms. Due to the size, energy cost, safety regulations, and operating requirements of utility-scale power production, the components, hardware design, construction means and methods, and operations and maintenance all have specific, unique features yielding the designation “utility-scale” typically at 1000V or 1500V DC generation sizing.

Since its inception, PV technology has been an expensive solution for power production. This is because the PV cells within the heart of the solar modules have been costly to manufacture and inefficient. However, over the past 40 years, significant strides have been made on PV cell and module manufacturing and technology fronts. These improvements have brought PV electricity costs below the more traditional utility-scale power generation methods in some geographical regions.

Today, two primary industry adopted technologies, Fixed Tilt (FT) racking and Single-Axis Tracking SAT, are commonly utilized as an industry-standard structural means to secure the solar panels to orient them to the sun and optimize the solar panel efficiency and increase energy production to lower the cost of electricity of the solar system. Fixed Tilt racking and Single-Axis Trackers are rigid mounting systems, typically made of structural steel, and are expensive to install and maintain.

Fixed Tilt and Single-Axis Tracking methods are often categorized as “ground mount” technologies, separating them from roof-mount technologies. “Ground Mount” means that the modules are supported by free-standing structures with dedicated foundations rather than buildings. Ground Mount technologies typically have the leading edge of the modules 1 ft or greater above finished grade and the high edge or trailing edge of the modules extending 10 ft or greater above finished grade. Steel-pile, reveal height for the structural racking is commonly 5 ft above grade with maximum and minimum being 3 ft-7 ft commonly depending on the configuration. Typical row spacing for rows of solar panels is 15-21 ft due to the tilt angle of the modules and to prevent row to row shading.

When deployed in large solar farms, solar panels are typically mounted on racks that orient the panels toward the sun. With gimballed racks, called trackers, the panel is pivoted to face the sun throughout the day by tracking the sun, with some systems also accounting for solar elevation or otherwise accounting for the sun's effect analemma. Fixed racking and tracking of PV modules increases the efficiency of the solar modules by better aligning the modules to the sunlight through optimization of the solar incidence angle. Rows of FT or SAT plants are commonly spaced at 15-21 ft row spacing to avoid shading from row to row throughout the day.

Generally, the nature of solar cells is such that they are generally waterproof and durable. For example, it is common for solar modules to be tested and certified to withstand hail of up to 25 mm (one inch) falling at about 23 m/sec (51 mph). While it is possible to clean solar panels, as a practical matter, racked solar panels are not frequently cleaned because the expense is not justified by expected energy loss resulting from dirt and dust accumulation. For example, in Southern California, the estimated energy loss from dirt and dust is approximately 5%/year, but if the panels were cleaned, the loss would be approximately 1%/year.

One consideration in mounting solar panels on racks or trackers is the albedo effect, resulting from sunlight reflecting from the ground, resulting in backside heating. This issue is addressed in various ways by coating the backside of the solar panels with a white coating. A disadvantage of doing that is that white coatings slow heat discharge through the module's backside. Today's industry commonly deploys bi-facial solar panels to extract additional energy from the solar panel in an FT or SAT configuration.

In typical configurations, the array output voltage (series voltage of the panels in a string) is 1500. Solar arrays are limited in voltage due to solar panel manufacturing maximum voltage limits, the National Electric Code, and International Electric Code. To limit the voltage, panels are arranged in strings that connect to the inverter through harnesses. The strings' physical arrangement on the trackers or racks requires harnessing equipment. Three sets of strings are used on a single tracker assembly in a typical tracker system. Harnesses of varying configurations are used to connect those strings to the inverter, although this number can change according to the rack's length and other considerations.

The harnesses themselves are a significant cost factor. Since the system is voltage-limited, the total power output of the plant translates to substantial wiring costs for harness systems. Similarly, power losses through the wiring harness translate to additional costs. Therefore, it is desired to provide a physical configuration of solar panels, rows, and arrays that reduce cable runs in connection harnesses.

One wiring harness configuration used with racked modules is called “skip stringing” or “leapfrog wiring”. In skip stringing, wiring harnesses bypass alternate panels to provide efficient wiring by limiting cabling to approximately the distance between alternating modules. The ability to achieve connections extending over a longer distance without a proportional increase in cabling allows positive and negative connections to be placed closer to the inverter, reducing the number of harness conductors needed to connect to the inverter. In addition, since the panels are alternately connected, the alternate panels within the same physical row can provide a return circuit, reducing the distance between an end panel and the inverter. Ideally, one positive or negative pole connection connecting the string to the inverter is only one panel away from the other pole connection. This reduces the length of the “home run” wire but requires each link to skip alternate panels to return along the same row.

While it would be possible to string panels across two or more rows, it would shorten the rows and increase costs. Instead, skip stringing wiring is used because, by skipping adjacent panels, the length of a string is maintained while providing for a return connection along the same row. This arrangement effectively doubles the length of a string over the length that would exist if the string were extended across two rows.

This stringing system accommodates the panels' polarities; however, this technique still requires wiring harnesses in the connection. In addition, these techniques still require additional harnesses to connect between the respective ends of the strings and the inverter. Finally, since adjacent rows of panels are separated by a space corresponding to the cast shadow of racked panels, it becomes impractical to string panels across rows.

Another issue involving racked or tracker-mounted solar panels is the effect of wind. Dependent upon installation location, the wind speed can vary from 85-140 mph in the USA. High wind forces, which can reach hurricane force strength, often preclude the construction of solar power plants in those regions or increase the expense by requiring very robust structural steel with deep foundations and large cross-sectional areas as the mean wind force resisting system. In addition, the modules themselves are easily damaged by high winds requiring significant repair and replacement expenditures due to cyclic loading on the structure with the modules tilted like sails in the wind as they are fixed above finished grade. Besides apparent damage resulting from the direct forces of wind, the adverse effects of cyclic loading can cause “microcracking”. This “micro-cracking” damage occurs over time, causing accelerated degradation rates of the module cells. This micro-cracking has become a serious issue for the industry influencing long-term module warranties.

Another issue involving racked or tracker-mounted solar panels is environmental corrosion due to corrosive soils and corrosive air such as salt spray. Typical ground-mount power plants use driven steel piles sized to counter the effects of wind loading on the overall structure. Pile sizing is determined by geotechnical corrosion test results and structural loading requirements to resist wind loading for the area. Pile sizing must account for the corrosion of the steel or other materials and still last for 25 years. The more corrosive the soil, the thicker the posts will be designed and used as sacrificial steel to ensure a 25-year life. Similar issues exist for geographies near the oceans where salt spray environments exist.

### SUMMARY

The Erthos Earth Mount System mounts the solar panels directly to the earth without an intermediate structure between the modules and the earth itself.

This disclosure covers a system for a PV module alignment or attachment system and a method of preparing PV module arrays. These arrays are used in utility-scale solar PV plants. The system contains multi-connectors that interact with the modules along rows or columns of a module array. The method for producing the array has various steps, including supplying the PV modules; and arranging the modules into an array in an earth mount configuration on the surface at a site of the plant or on an earth surface. The modules and multi-connectors follow the contour of the ground. These multi-connectors maintain a module-to-module edge alignment. In some versions, the multi-connectors maintain the modules such that an autonomous cleaning robot can traverse from module to module. The multi-connectors interact with the modules through a penetration in the module or a module clip that sometimes contains a similar penetration. The array may comprise rows larger than 25 or 50 modules and columns larger than 6, 17, 14, 29, or 50 modules.

The array is lined on at least one side by leading edges in some versions.

### BRIEF DESCRIPTION OF THE FIGURES

FIG. 1 is a perspective view of a multi-connector.

FIG. 2A is a perspective view of a PV module.

FIG. 2B is a cross-section view of the PV module frame of FIG. 2A.

FIG. 3A is a perspective view of a PV module.

FIG. 3B is a perspective view of a PV module.

FIG. 3C is a perspective view of a PV module.

FIG. 4A is a perspective view of an array of PV modules with a multi-connector.

FIG. 4B is a magnified view of part of FIG. 4A.

FIG. 5A is a perspective view of a PV module.

FIG. 5B is a magnified view of part of FIG. 5A.

### DETAILED DESCRIPTION

Unless defined otherwise, all technical and scientific terms used in this document have the same meanings as commonly understood by one skilled in the art to which the disclosed invention pertains. Singular forms—a, an, and the—include plural referents unless the context indicates otherwise. Thus, reference to “fluid” refers to one or more fluids, such as two or more fluids, three or more fluids, etc. When an aspect is to include a list of components, the list is representative. If the component choice is limited explicitly to the list, the disclosure will say so. Listing components acknowledges that exemplars exist for each component and any combination of the components—including combinations that specifically exclude any one or any combination of the listed components. For example, “component A is chosen from A, B, or C” discloses exemplars with A, B, C, AB, AC, BC, and ABC. It also discloses (AB but not C), (AC but not B), and (BC but not A) as exemplars, for example. Combinations that one of ordinary skill in the art knows to be incompatible with each other or with the components' function in the invention are excluded, in some exemplars.

When an element or layer is called being “on”, “engaged to”, “connected to” or “coupled to” another element or layer, it may be directly on, engaged, connected, or coupled to the other element or layer, or intervening elements or layers may be present. When an element is called being “directly on”, “directly engaged to”, “directly connected to”, or “directly coupled to” another element or layer, there may be no intervening elements or layers present. Other words used to describe the relationship between elements should be interpreted in a like fashion (e.g., “between” versus “directly between”, “adjacent” versus “directly adjacent”, etc.).

Although the terms first, second, third, etc., may describe various elements, components, regions, layers, or sections, these elements, components, regions, layers, or sections should not be limited by these terms. These terms may distinguish only one element, component, region, layer, or section from another region, layer, or section. Terms such as “first”, “second”, and other numerical terms do not imply a sequence or order unless indicated by the context. Thus, a first element, component, region, layer, or section discussed below could be termed a second element, component, region, layer, or section without departing from this disclosure.

Spatially relative terms, such as “inner”, “outer”, “beneath”, “below”, “lower”, “above”, “upper” may be used for ease of description to describe one element or feature's relationship to another element or feature as illustrated in the figures. Spatially relative terms may be intended to encompass different orientations of the device in use or operation besides the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations), and the spatially relative descriptors interpreted.

The description of the exemplars has been provided for illustration and description. It is not intended to be exhaustive or to limit the invention. Individual elements or features of a particular exemplar are not limited to that exemplar but, where applicable, are interchangeable and can be used in a selected exemplar, even if not explicitly shown or described. The same may also be varied. Such variations are not a departure from the invention, and all such modifications are included within the invention's scope.

### TECHNOLOGY

The disclosed technology provides a technique for generating electricity using commercially available utility-scale PV (e.g., CSi, CdTe, CIGS, CIS) modules, new and novel adaptations of these modules, or new module technologies. A group of modules is mounted in direct contact and parallel with the Earth's surface. This mounting establishes an earth orientation of the PV modules, as distinguished from a solar orientation. But contouring of the soil and other mounting considerations will account for the sun's angle.

The modules are tiled into a grid pattern edge to edge and end to end. This technology does not limit how the modules attach to one another or the Earth. This arrangement of modules substantially reduces the wind loading effects of the modules. The electrical arrangement of the modules allows for both series and parallel connections and eliminates, but does not preclude, the need for discrete wiring harnesses and harness supporting means used by traditional utility-scale solar plant PV power plant systems. This module arrangement provides significant advantages when used with string or microinverters but is equally suitable for industry-standard central inverters or alternate power conversion and transmission technologies.

Modules using prior art conductive module-support structures require module bonding and grounding to meet code.

This module arrangement dispenses with steel and steel structures in the power plant and their corrosion while increasing power plant life sometimes to greater than 40 years. But steel, coated or otherwise, may be used with these systems.

The arrangement of modules allows for both commercially available and new techniques for module cleaning and dust removal, increasing the effective energy production rate.

The module arrangement reduces high wind (sometimes hurricane strength) forces on the modules, which increases the cost of or often precludes construction of solar power plants in high-wind regions. Since high winds easily damage the modules, removing them from high winds reduces repair and replacement costs.

This technology allows for module cooling methods such as evaporative cooling, applying high emissivity coatings, adding “air vents” on module edges, adding heat transfer materials, or using heat transfer methods, increasing the modules' energy production rates. In addition, ground positioning avoids module heating from indirect sunlight and sunlight-heated ground. This positioning transforms the ground from a heat source to a heat sink.

The disclosed technology increases the power density per acre of land. As a result, the quantity of acres used per power production unit is reduced by over 50% from traditional utility-scale solar plant PV power plants. In addition, this technology eliminates row to row spacing as required to prevent shading of rows of modules.

Since the disclosed technology allows the PV array to follow existing land contours, the typical need for mass grading, plowing, tilling, cutting, and filling within arrays can be reduced or eliminated.

While not tracking the sun reduces module performance, the overall cost savings from reduced electrical losses in wiring, removal of the structural steel racking system, energy increases from increased module cleaning, reduced material cost, and reduced construction schedule and risk costs yields a reduced produced energy price (LCOE) of greater than 10% over current technologies.

This adjacent positioning allows wiring connections or harnesses to take advantage of the adjacent relationships across two or more rows, reducing the need for harness connections. Module to module string connection distances are reduced in a particular arrangement because adjacent rows can be connected without “skip stringing” or “leapfrog wiring”. DC Homerun connections, commonly called “whips,” are reduced due to eliminating row-to-row spacing requirements. In an alternate arrangement, sequential connections can be made with “next” panels in adjacent rows, reducing the length of connections required for “skip stringing” or “leapfrog wiring”.

Eliminating structural racking affords an additional advantage with wire harnessing. Since there are no racks, there is no need to consider racks and associated wire management when designing wire harnesses. Thus, module strings can terminate at both ends of the strings close to the inverters. Multiple strings closely terminating allows inverter positioning close to string end terminations.

Multi-Connectors

The multi-connector system is a flexible module retaining and mounting system used in Earth-mounted solar PV utility-scale installations. The multi-connector mechanically and structurally retains PV modules of an array and electrically bonds or grounds module frames to each other. This interconnection is between one to four adjacent modules. The interconnection is flexible, which facilitates more significant module-to-module grade changes. Thus, the array will not be damaged by mounting on soils that have a marked change in nature over the array, such as changing between expansive and contractive soils. In addition, the electrical connectivity creates a redundant ground or bond between adjacent modules that extend module-wise across the entire array.

In some exemplars, the multi-connector system facilitates incorporating more modules into arrays or islands than some systems using perimeter blocks, which decreases the costs of the perimeter blocks.

The multi-connector system flanges provide pivot points to better tolerate module to module grade changes without increasing the gap between module frames caused by more significant grade changes.

The multi-connector component inhibits module overlap while remaining flexible for grade changes. In addition, this system or racking method creates automatic lateral spacing between adjacent solar modules.

| | |
|---|---|
| multi-connector | 100 |
| flexible arm | 200 |
| electrical connector | 300 |
| ferrule | 400 |
| tap | 410 |
| bonding hole | 450 |
| flange-short | 500 |
| flange-long | 600 |
| module | 12 |
| frame | 13 |
| bolt | 14 |
| equipment grounding conductor | 15 |
| wire connection | 16 |
| perimeter block | 50 |
| frame profile | 700 |
| weep hole | 114 |

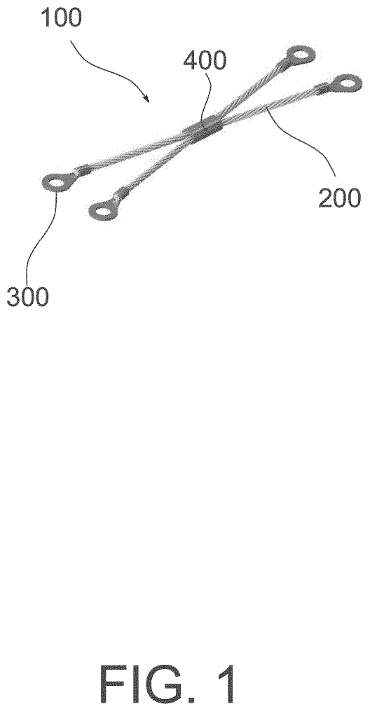

FIG. 1 depicts multi-connector 100. Multi-connector 100 has, in this exemplar, four flexible arms 200 extending from ferrule 400. Electrical connectors 300 terminate each arm 200.

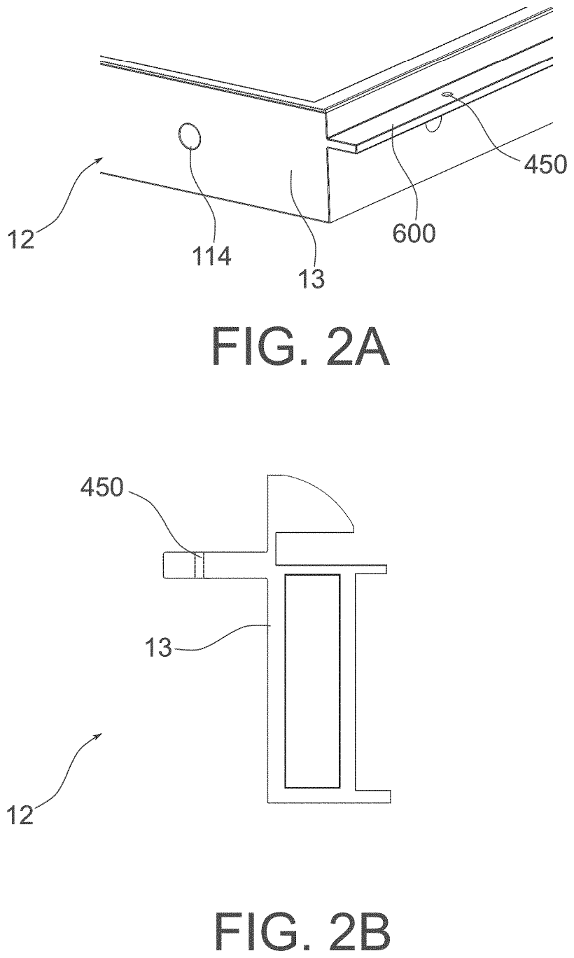

FIG. 2A depicts a portion of the PV module 12 having frames 13. This version shows frame 13 with weep hole 114 and flange-long 600. Bonding hole 450 pierces flange-long 600. FIG. 2B depicts a profile of the extrusion that forms frame 13. In this exemplar, frame 13 has flange-long 600.

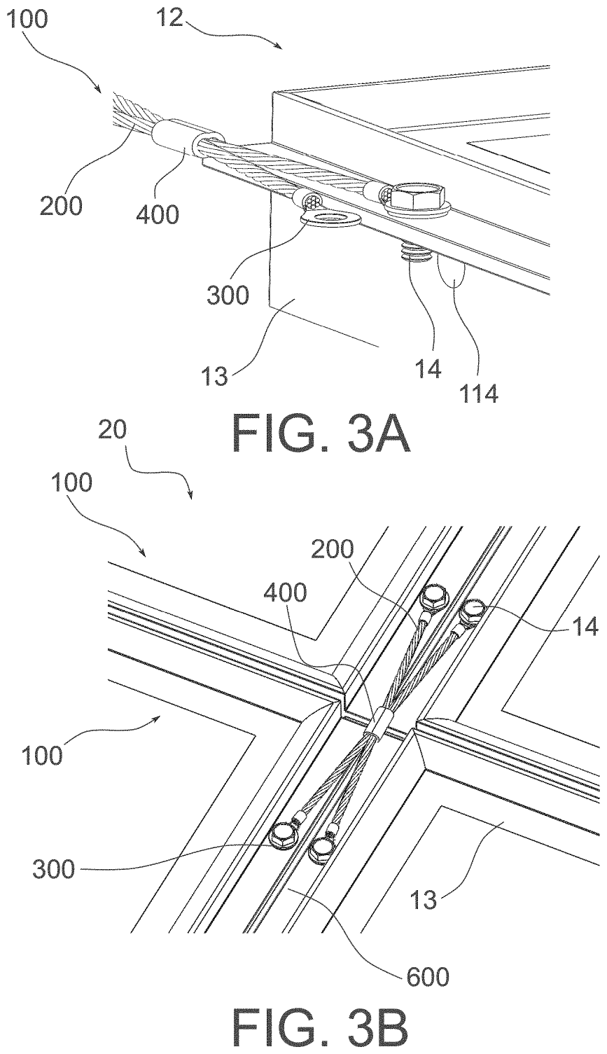

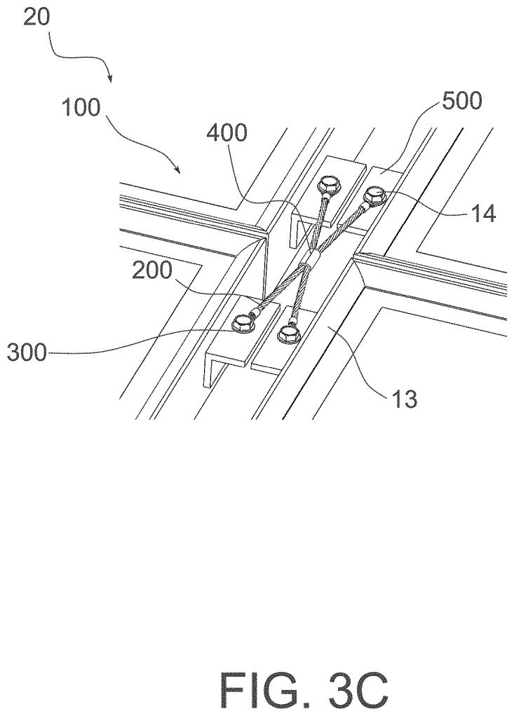

FIG. 3A depicts a perspective view of a corner of module 12 showing the electrical connectors 300 of a single flexible arm 200 of the multi-connector 100 attached to frame 13 of module 12 using bolt 14. In this figure, bolt 14 threads into bonding hole 450. The figure shows module 12 with flange-long 600. FIG. 3B depicts four of module 12 arranged as the modules would be arranged in an array 20 of modules. Array 20 contains modules 12 nominally mounted flat on the ground, such as in an Earth Mount system. Four modules 12 meet at the corners of each module 12 with a flexible arm 200 connected to each module 12. This arrangement creates a connection among all four modules 12.

FIG. 3C depicts an arrangement of modules like that of FIG. 3B except that FIG. 3C depicts flange-short 500 instead of flange-long 600.

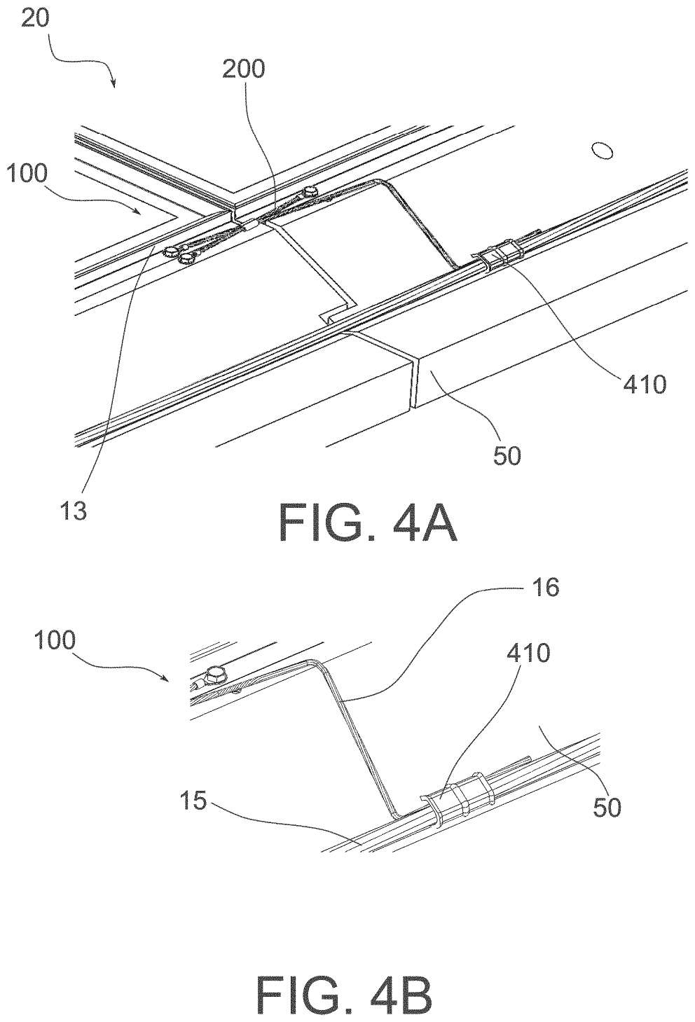

FIG. 4A depicts an edge of array 20 abutting perimeter block 50. In this arrangement, two flexible arms 200 connect to flange-long 600, and two flexible arms 200 connect to perimeter block(s) 50. Equipment grounding conductor 15 runs along the perimeter of array 20 along perimeter block(s) 50.

FIG. 4B is an expanded view of the collection of FIG. 4 A. It shows wire connection 16 connecting between multi-connector 100 and equipment grounding conductor 15. In this exemplar, wire connection 16 and equipment grounding conductor 15 are joined with tap 410.

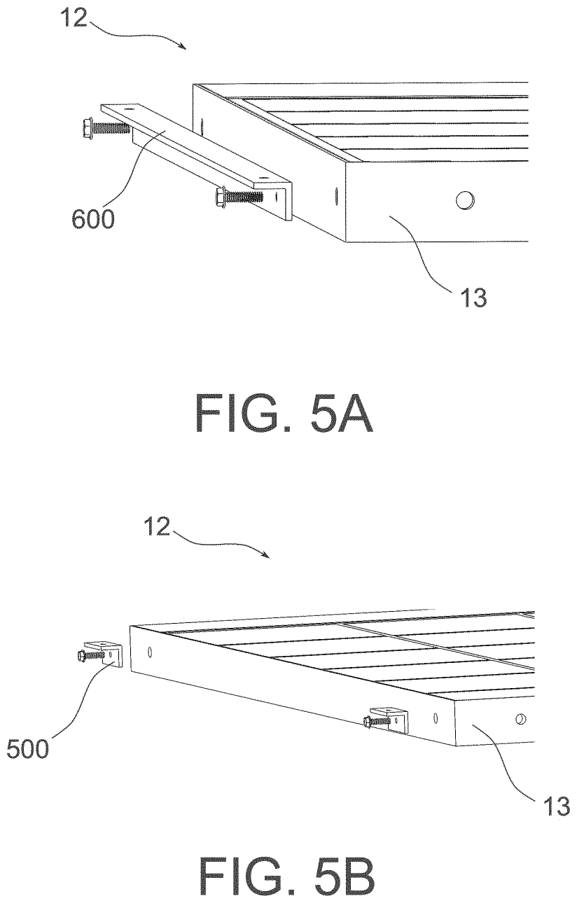

FIG. 5A shows module 12 having a bolted-on version of flange-long 600. Flange-long 600 connects to frame 13 with bolts, screws, or other connectors. FIG. 5B shows module 12 having a bolted-on version of flange-short 500. Flange-short 500 connects to frame 13 with bolts, screws, or other connectors.

In operation, the multi-connector creates a mechanical connection and electrical bond between adjacent modules in an array of modules.

The multi-connector component captures all four corners of adjacent modules, retaining them within horizontal and vertical height tolerance requirements for mounting and wind loading.

The multi-connector system can be installed on existing module frame technology using a bolt-on flange to module frame or be employed by using a new Erthos designed extruded module frame.

The multi-connector flange is threaded to meet NEC grounding requirements for the number of threads per inch of metallic contact.

What is claimed is:

1. A method comprising:
supplying PV modules having faces;
and
installing an array of the modules in an earth mount configuration on an earth surface having a contour,
wherein the array comprises a multi-connector and the multi-connector joins at least some modules at adjoining corners.

2. The method of claim 1, wherein the multi-connector maintains a module-to-module edge alignment.

3. The method of claim 2, wherein the multi-connector interacts with a module through a frame.

4. The method of claim 3, wherein the array comprises a row of greater than 25 or 50 modules.

5. The method of claim 4, wherein the array comprises a column of greater than 6, 17, 14, 29, or 50 modules.

6. The method of claim 5, wherein the frame comprises holes.

7. The method of claim 6, wherein the array comprises a leading edge.

8. The method of claim 7, wherein the multi-connector maintains module-to-module edge alignment for face-to-face angles of 0 to 30 degrees.

9. The method of claim 8, wherein the multi-connector connects to flanges on the frame.

10. The method of claim 9, wherein flanges are on the frames of two sides of the module.

11. The method of claim 10, wherein the multi-connector comprises four flexible arms.

12. The method of claim 11, wherein the four flexible arms are composed of two pairs of wire rope connected at a midpoint of each pair.

13. The method of claim 12, wherein the multi-connector further comprises a wire connection that extends to an equipment ground connection or the array.
